(19) United States
(12) Patent Application Publication
(10) Pub. No.: US 2026/0202611 A1
(43) Pub. Date: Jul. 16, 2026

(54) OPTICAL WAVEGUIDE STRUCTURE AND CONTROL METHOD

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Yuki KAMATA, Nisshin-shi (JP)

(21) Appl. No.: 19/416,432

(22) Filed: Dec. 11, 2025

(30) Foreign Application Priority Data
Jan. 13, 2025 (JP) 2025-004458

(51) Int. Cl. G02B 6/12

(52) U.S. Cl. CPC G02B 6/12019; G02B 2006/12085; G02B 2006/12107; G02B 2006/12135; G02B 2006/1215

(57) ABSTRACT

An optical waveguide structure includes an optical splitter, a plurality of phase adjusters, an optical phased array, and a plurality of correction antennas. The optical splitter is configured to split an input optical signal to a plurality of optical waveguides. The plurality of phase adjusters are each connected to a respective one of the plurality of optical waveguides. Each of the plurality of phase adjusters is configured to control a phase of light propagating through the plurality of optical waveguides. The optical phased array is formed of a plurality of optical antennas. Each of the plurality of optical antennas is connected to a respective one of the plurality of phase adjusters. The plurality of correction antennas are optically isolated from the optical phased array. The plurality of correction antennas are disposed to face each other, and the optical phased array is disposed between the plurality of correction antennas.

### CROSS REFERENCE TO RELATED APPLICATION

The present application claims the benefit of priority from Japanese Patent Application No. 2025-004458 filed on Jan. 13, 2025. The entire disclosure of the above application is incorporated herein by reference.

### TECHNICAL FIELD

The present disclosure relates to an optical waveguide structure having an optical waveguide and capable of forming an optical beam in an arbitrary direction, and a control method thereof.

### BACKGROUND ART

There is an optical waveguide structure which has an optical waveguide and is configured to emit phase-controlled light from optical antennas arranged in an array.

### SUMMARY

According to one aspect of the present disclosure, an optical waveguide structure may include an optical splitter, multiple phase adjusters, an optical phased array, and multiple correction antennas. The optical splitter is configured to split an input optical signal to multiple optical waveguides. The multiple phase adjusters are each connected to a respective one of the multiple optical waveguides. Each of the multiple phase adjusters is configured to control a phase of light propagating through the multiple optical waveguides. The optical phased array is formed of multiple optical antennas each of which is connected to a respective one of the multiple phase adjusters. The multiple correction antennas may be optically separated from the optical phased array. The multiple correction antennas may be disposed to face each other, and the optical phased array may be disposed between the multiple correction antennas.

### BRIEF DESCRIPTION OF DRAWINGS

FIG. 1 is a block diagram showing an optical waveguide structure and a control unit according to a first embodiment.

FIG. 2 is a perspective view showing the schematic configuration of the optical waveguide structure according to the first embodiment.

FIG. 3 is a perspective view showing the schematic configuration of light emission regions of the optical antenna and the correction antenna.

FIG. 4 is a diagram illustrating a view as seen from the direction IV in FIG. 3, and explains the state in which no thickness gradient or warpage is present in the optical antenna.

FIG. 5 is a diagram corresponding to FIG. 4, illustrating the state in which a thickness gradient has occurred in the optical antenna.

FIG. 6 is a diagram showing the distribution of the light intensity of the emitted light with respect to the angle from the optical antenna, in both the state where a thickness gradient is not present and the state where the thickness gradient is present.

FIG. 7 is a diagram corresponding to FIG. 4, illustrating the state in which warpage has occurred in the optical antenna.

FIG. 8 is a diagram showing the distribution of the light intensity of the emitted light with respect to the angle from the optical antenna, in both the state where warpage is not present and the state where warpage is present.

FIG. 9 is a diagram illustrating the estimation of the thickness gradient and warpage of the correction antenna, using actual measurement results of the FFP of radiation from the correction antenna.

FIG. 10 is a diagram illustrating the effect of temperature control in a state where a thickness gradient has occurred in the optical antenna.

FIG. 11 is a diagram illustrating the effect of temperature control in a state where warpage has occurred in the optical antenna.

FIG. 12 is a diagram illustrating the FFP of radiation from two correction antennas and the temperature distribution for correction.

FIG. 13 is a diagram illustrating the temperature gradient in the optical waveguide structure of the first embodiment.

FIG. 14 is a diagram showing the simulation results of the FFP of radiation from the correction antenna before and after temperature distribution control, and the FFP of the correction antenna in the ideal state.

FIG. 15 is a perspective view showing the schematic configuration of an optical waveguide structure of a second embodiment.

FIG. 16 is a perspective view showing the schematic configuration of an optical waveguide structure of a third embodiment.

### DESCRIPTION OF EMBODIMENTS

To begin with, examples of relevant techniques will be described.

Conventionally, an optical waveguide structure is known which has an optical waveguide and is configured to emit phase-controlled light from a plurality of optical antennas arranged in an array, thereby forming optical beams in arbitrary directions based on the phase pattern of the emitted light. This type of optical waveguide structure is also referred to as an optical phased array.

The optical waveguide structure described above forms an optical antenna, and includes multiple optical waveguides, which extend in one direction, and multiple diffraction gratings, which are arranged adjacent to the optical waveguides and aligned along the one direction. In the optical waveguide structure as the optical antenna, the optical waveguides and the diffraction gratings are separated from each other, and arranged along the one direction, thereby extending the length of the optical antenna, i.e., the antenna length. As a result, the optical waveguide structure forms an optical beam having a highly directional light intensity distribution (FFP). FFP stands for Far-Field Pattern.

As a result of diligent investigation by the present inventors, it has newly been found that, in this type of optical waveguide structure, when a thickness gradient occurs in the optical antenna or warping arises in the chip on which the optical antenna is formed, the phases of the light emitted from the diffraction gratings become misaligned, leading to a significant decrease in the FFP.

In view of the above, the present disclosure provides an optical waveguide structure and a method for controlling the same, which are capable of suppressing a decrease in FFP, that is, a reduction in the directivity of the optical beam, caused by a thickness gradient in the optical waveguide or warping of the chip.

According to one aspect of the present disclosure, an optical waveguide structure includes an optical splitter, multiple phase adjusters, an optical phased array, and multiple correction antennas. The optical splitter is configured to split an input optical signal to multiple optical waveguides. The multiple phase adjusters are each connected to a respective one of the multiple optical waveguides. Each of the multiple phase adjusters is configured to control a phase of light propagating through the multiple optical waveguides. The optical phased array is formed of multiple optical antennas each of which is connected to a respective one of the multiple phase adjusters. The multiple correction antennas are optically separated from the optical phased array. The multiple correction antennas are disposed to face each other, and the optical phased array is disposed between the multiple correction antennas.

In addition to the optical phased array, the optical waveguide structure includes correction antennas that are optically separated from the optical phased array and are arranged to facing each other with the optical phased array interposed therebetween, so that light is also emitted from the correction antennas. Furthermore, the optical waveguide structure can estimate the thickness gradient and warpage occurring in each of the correction antennas, based on the optical characteristics of the light emitted from the correction antennas. The optical waveguide structure is configured to suppress deterioration in the directivity of the light beam emitted from the optical phased array interposed between the multiple correction antennas by correcting the differences in optical characteristics among the multiple correction antennas, which are caused by the estimated film thickness gradient and warpage, to be within a predetermined range.

According to another aspect of the present disclosure, a method for controlling an optical waveguide structure including a semiconductor substrate and a heater configured to heat the semiconductor substrate is provided. The semiconductor substrate includes an optical phased array that is formed of multiple optical antennas, and multiple correction antennas that are optically isolated from the optical phased array and disposed to face each other through the optical phased array. The control method includes measuring an optical characteristic of light emitted from the correction antennas, calculating, based on the optical characteristic, a target thermal distribution in a region between and including the correction antennas, and controlling the heater to heat the semiconductor substrate to achieve the target thermal distribution. The thermal distribution causes a difference in the optical characteristic among the correction antennas to fall below a threshold.

The method for controlling the optical waveguide structure includes three steps: measuring the optical characteristics of light emitted from the correction antennas, calculating the target temperature distribution that causes a difference in the optical characteristics among the correction antennas to fall below a threshold based on the measured optical characteristics, and controlling the heater to heat the semiconductor substrate to achieve the target temperature distribution. As a result, it is possible to correct deviations in optical characteristics caused by thickness gradients and warping occurring in the optical phased array disposed between the multiple correction antennas, thereby suppressing the deterioration of the directivity of the light beam emitted from the optical phased array.

Hereinafter, embodiments of the present disclosure will be described with reference to the drawings. It should be noted that, in the following embodiments, identical or equivalent parts are denoted by the same reference numerals and will be explained accordingly. In addition, in the embodiments, when only part of a component is described, the components described in the preceding embodiments may be applied to the other parts of the component. The following embodiments may be partially combined with one another, insofar as such combinations do not cause any particular problems, even if not explicitly stated.

(First Embodiment) An optical waveguide structure 1 according to the first embodiment will be described.

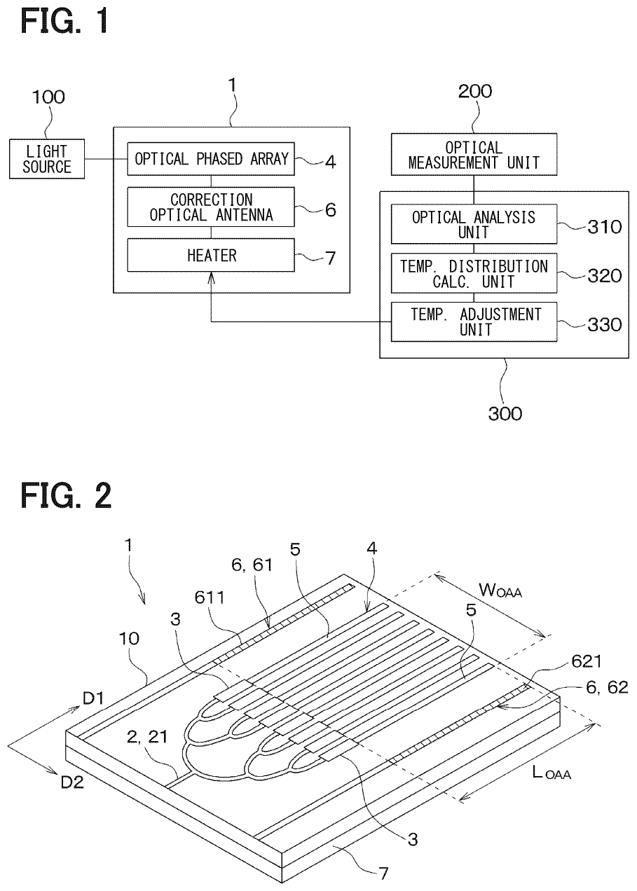

(Basic Configuration) The optical waveguide structure 1 of the present embodiment, as shown in FIG. 1, includes an optical phased array 4, correction antennas 6, and a heater 7. Incident light from a light source 100 is transmitted to the optical phased array 4, and a highly directional light beam is emitted from the optical phased array 4. The light source 100 may be a known infrared laser light source, but is not limited thereto.

As shown in FIG. 2, the optical waveguide structure 1 is formed on a semiconductor substrate 10, and includes an optical splitter 2, phase adjusters 3, an optical phased array 4 formed of optical antennas 5, and the correction antennas 6. In the present embodiment, the heater 7 is bonded by an adhesive (not shown) to the surface of the semiconductor substrate 10 opposite to the surface on which the optical phased array 4 is formed.

Except for the heater 7, the optical waveguide structure 1 is formed on the semiconductor substrate 10 using silicon photonics technology, and is configured as a single optical integrated chip. The semiconductor substrate 10 may be formed as a rectangular plate and formed of silicon (Si), or may be made of other known materials. The optical waveguide structure 1 may be formed by providing a lower cladding layer on the semiconductor substrate 10, forming a patterned core layer constituting each waveguide on the lower cladding layer, and then forming an upper cladding layer that covers both the core layer and the lower cladding layer. The lower cladding layer and the upper cladding layer may be formed of silicon oxide (SiO₂), or may be formed of other known materials. The core layer constitutes each optical waveguide forming the optical waveguide structure 1, and may be formed of Si, or other known materials.

Hereinafter, for convenience of explanation, of the two orthogonal directions in the plane of the semiconductor substrate 10 in a state without warpage, one direction along the longitudinal direction of the optical antenna 5 is referred to as a “vertical direction D1,” and the other direction is referred to as a “horizontal direction D2”, as shown in FIG. 2, In addition, in FIG. 2, for the sake of clarity regarding the structure of the optical waveguide structure 1, mainly the portions of the core layers constituting each waveguide are shown, and simplified representations of the optical antennas 5 and the correction antennas 6 are depicted.

The optical splitter 2 divides incident light from the light source 100 into multiple branches and transmits the branched incident light to the optical antennas 5 that form the optical phased array 4. The optical splitter 2 may have one end formed by a single optical waveguide 21, which branches into two optical waveguides toward the other end, and each of the two optical waveguides further branches into two optical waveguides toward the other end, thereby forming a branching structure. The phase adjusters 3 are connected to the branches of the optical waveguides 21, respectively.

The phase adjusters 3 are configured to adjust the phase of each guided light branched and transmitted from the optical splitter 2. The phase adjusters 3 are used to control the emission angle and pattern of the light beam emitted externally from the optical phased array 4. The phase adjusters 3 are configured to generate a desired phase difference in guided light by locally heating each of the waveguides of the optical splitter 2 using a heater (not shown) arranged on each of the waveguides of the optical splitter 2, and by changing the refractive index of the waveguides through the thermo-optic effect. The guided light passing through the phase adjusters 3 may be transmitted to different optical antennas 5.

The optical phased array 4 has the optical antennas 5 linearly extending in the vertical direction D1, and the optical antennas 5 are arranged apart from each other in the horizontal direction D2. In order to ensure the directivity of the light beam emitted externally, the length of the optical antenna 5 of the optical phased array 4 in the vertical direction D1 (the antenna length L_{OAA}) is set to a predetermined value or greater (for example, several millimeters to several centimeters). For the same purpose, the width of the optical antenna 5 in the horizontal direction D2 (the antenna array width W_{OAA}) is set to a predetermined value or greater (for example, several millimeters to several centimeters).

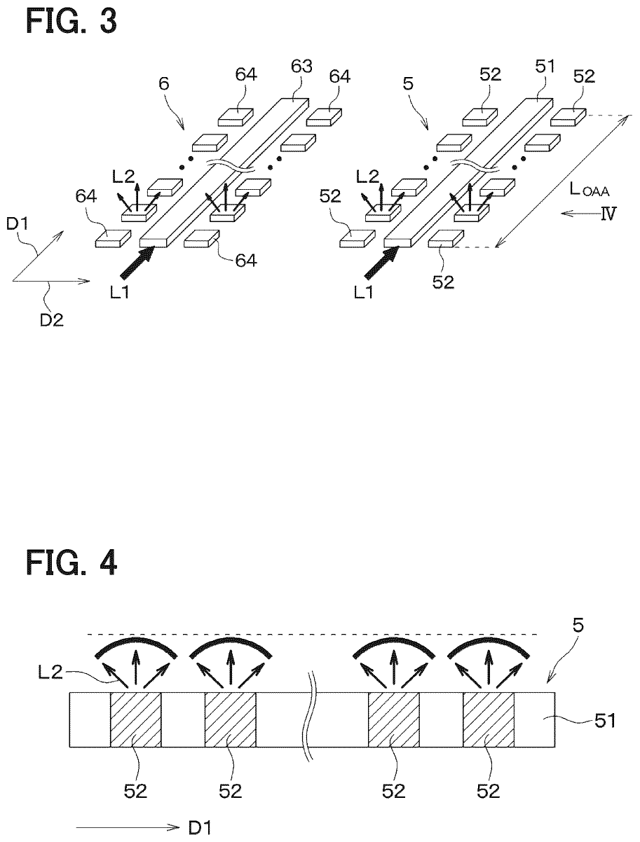

As shown in FIG. 3, each of the optical antennas 5 consists of an optical waveguide 51 that extends linearly in the vertical direction D1, and diffraction gratings 52 disposed on both sides of the optical waveguide 51 in the horizontal direction D2. The diffraction gratings 52 are arranged periodically at predetermined intervals in the vertical direction D1. As indicated by the arrows in FIG. 3, the input light L1 introduced into the optical waveguide 51 propagates through the optical waveguide 51, and the input light L1 is emitted externally as radiation light L2 from the block-shaped diffraction gratings 52. The optical antenna 5 is optimized in the spacing between the optical waveguide 51 and the diffraction gratings 52 in the horizontal direction D2, the width of the optical waveguide 51 in the vertical direction D1, and the width of the diffraction gratings 52 in the vertical direction D1, to uniformly emit the radiation light L2 from the diffraction gratings 52. The optical waveguide 51 and the diffraction gratings 52 may be formed of a core layer. The optical waveguide 51 and the diffraction gratings 52 are arranged in the common layer on the semiconductor substrate 10, and are made of the same material.

Each of the correction antennas 6 is configured to correct the FFP of the light beam from the optical phased array 4, which is affected by the thickness gradient of the optical waveguide 51 in the vertical direction D1 and the warping of the semiconductor substrate 10. In this embodiment, the number of the correction antennas 6 is two and the two correction antennas 6 are respectively disposed on both sides of the optical phased array 4 in the horizontal direction D2, as a first correction antenna 61 and a second correction antenna 62. The first correction antenna 61 disposed on the left side of the optical phased array 4 and the second correction antenna 62 disposed on the right side are arranged in parallel with the optical antennas 5, with the extending directions of the correction antennas 61 and 62 aligned with the extending direction of the optical antennas 5. The correction antennas 61 and 62 have similar configurations. The number of correction antennas 6 is less than the number of optical antennas 5 forming the optical phased array 4.

Specifically, each of the correction antennas 6 is formed of an optical waveguide 63 and diffraction gratings 64, like the optical antenna 5 as shown in FIG. 3. The optical waveguide 63 extends linearly in the vertical direction D1. The diffraction gratings 64 may be block-shaped rectangular plates. The diffraction gratings 64 are arranged on both sides of the optical waveguide 63 in the horizontal direction D2, and periodically arranged at predetermined intervals in the vertical direction D1. A part of the correction antenna 6 in the region facing the optical antenna 5 in the horizontal direction D2 is formed of the optical waveguide 63 and the diffraction gratings 64, and the other parts are formed only of the optical waveguide 63.

Hereinafter, for convenience of explanation, the region of the correction antenna 6 in which the diffraction gratings 64 are arranged (i.e., the region that emits radiation externally) will be referred to as a “light emission region.” In addition, the light emission region of the first correction antenna 61 and the light emission region of the second correction antenna 62 are referred to as “light emission region 611” and “light emission region 621,” respectively. It should be noted that, in FIG. 2, hatching is applied to the light emission regions 611 and 621 to make them easier to distinguish from each other, and the hatching does not show a cross-section.

Each of the light emission regions 611 and 621 is a region of the correction antenna 6 extending from the diffraction grating 64 disposed at one end in the vertical direction D1 to the diffraction grating 64 disposed at the other end in the same direction. The correction antenna 6 has a length of the light emission regions 611, 621 in the vertical direction D1 (i.e., the antenna length) that is substantially the same as that of the optical antenna 5. The term “substantially the same” includes not only cases where they are exactly identical, but also cases where there are slight differences due to unavoidable manufacturing errors or the like, as long as they can be regarded as nearly identical.

Regarding the correction antennas 6, the spacing between the optical waveguide 63 and the diffraction gratings 64 in the horizontal direction D2, the width of the optical waveguide 63 in the vertical direction D1, and the width of each of the diffraction gratings 64 in the vertical direction D1 are the same as those of the optical antennas 5. The optical waveguide 63 and the diffraction gratings 64 may be formed of a core layer. The optical waveguide 63 and the diffraction gratings 64 are disposed in the common layer on the semiconductor substrate 10, and are made of the same material. Furthermore, the optical waveguide 63 is disposed in the common layer as the optical waveguide 51 and is made of the same material as the optical waveguide 51. The correction antennas 6 are formed simultaneously with the optical antennas 5 in the same process, so that the thickness gradient of the optical waveguides 63 in the vertical direction D1 is the same as that of the optical waveguides 51. Correction of the FFP in the optical phased array 4 using the correction antennas 6 will be described later.

In the present embodiment, the heater 7 is separately formed from the semiconductor substrate 10, and may be a known microheater array in which minute heating elements are arranged in an array. For example, the heater 7 is adhesively fixed by an adhesive (not shown) to the surface of the semiconductor substrate 10 opposite to the surface on which each optical waveguide is formed. The heater 7 may have substantially the same planar dimensions as the semiconductor substrate 10, but is not limited thereto, as long as the heater 7 can heat a predetermined region that includes at least the optical phased array 4 and the correction antennas 6. The heater 7 is driven and controlled by a temperature control unit 300, which will be described later, and is used to adjust the semiconductor substrate 10 to a predetermined temperature distribution.

The above is the basic configuration of the optical waveguide structure 1.

(Effects on FFP Due to Thickness Gradient and Warpage) Next, the influence of thickness gradient and warpage on the FFP in the optical phased array 4 will be explained. Hereinafter, for the sake of simplicity in explanation, the thickness gradient in the vertical direction D1 of the optical antennas 5 and the correction antennas 6 will be simply referred to as “film thickness gradient,” and the warpage of the semiconductor substrate 10, the optical antennas 5, or the correction antennas 6 will be simply referred to as “warpage.”

When the optical antennas 5 does not have any thickness gradient or warpage, the phases of the emitted light radiated externally from the diffraction gratings 52 are aligned, as shown in FIG. 4. The same applies to the correction antennas 6.

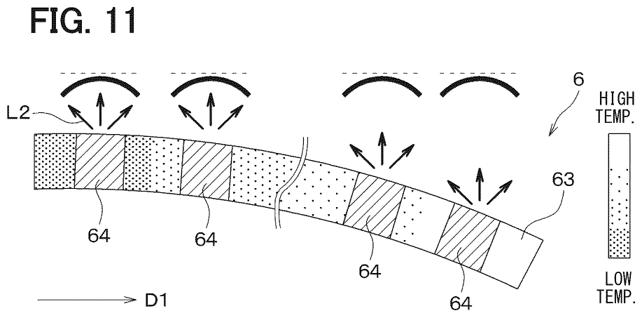

It should be noted that, in FIGS. 4, 5, and 7, hatching is applied to the diffraction gratings 52 to distinguish between the optical waveguide 51 and the diffraction gratings 52, although the hatching does not indicate the cross-section. Additionally, each emitted light from the diffraction gratings 52 is indicated by a bold arrow, and the phase of each emitted light is conveniently represented by a dashed line. Furthermore, in FIGS. 4, 5, and 7, the height position of the dashed lines is aligned when the phases are matched, and offset when there is a phase shift, to clearly indicate whether there is any phase shift in the emitted light from the diffraction gratings 52. Similarly, in FIGS. 10 and 11, as with FIG. 4, hatching is applied to the diffraction gratings 64, each emitted light is indicated by a bold arrow, and the phase of each emitted light is shown with a dashed line, with the position of the phase represented by its height position.

Through extensive research by the present inventors, it has newly been found that when the optical antennas 5 develop a thickness gradient, warpage, or both, the FFP changes, resulting in a decrease in the directivity of the optical beam emitted from the optical phased array 4.

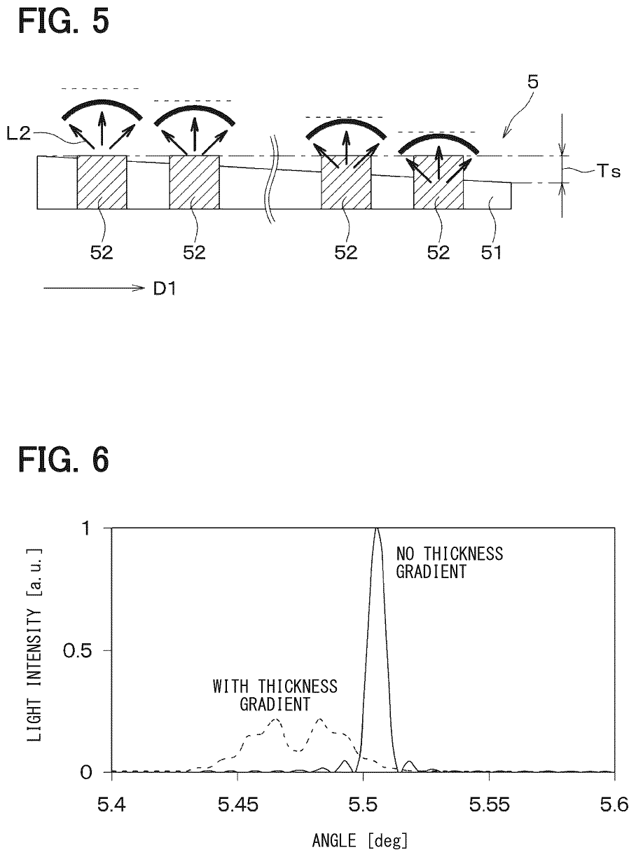

For example, as shown in FIG. 5, suppose that the optical waveguide 51 of the optical antenna 5 has no warpage, but a thickness gradient Ts in which the film thickness gradually decreases from one end to the other in the vertical direction D1. Here, the film thickness gradient Ts refers to the amount of variation (nm/mm) in the film thickness (nm) of the optical waveguide 51 per unit length (mm) in the vertical direction D1. In this case, the phases of the emitted light from the diffraction gratings 52 that are periodically arranged are misaligned because the thickness of the optical waveguide 51 on both sides of each diffraction grating differs between the diffraction gratings 52. As shown in FIG. 6, when there is no thickness gradient, the FFP of the light emitted from the optical phased array 4 forms a light beam with high intensity at a predetermined angle. In contrast, when the above-described thickness gradient occurs, a light beam with high intensity is not formed.

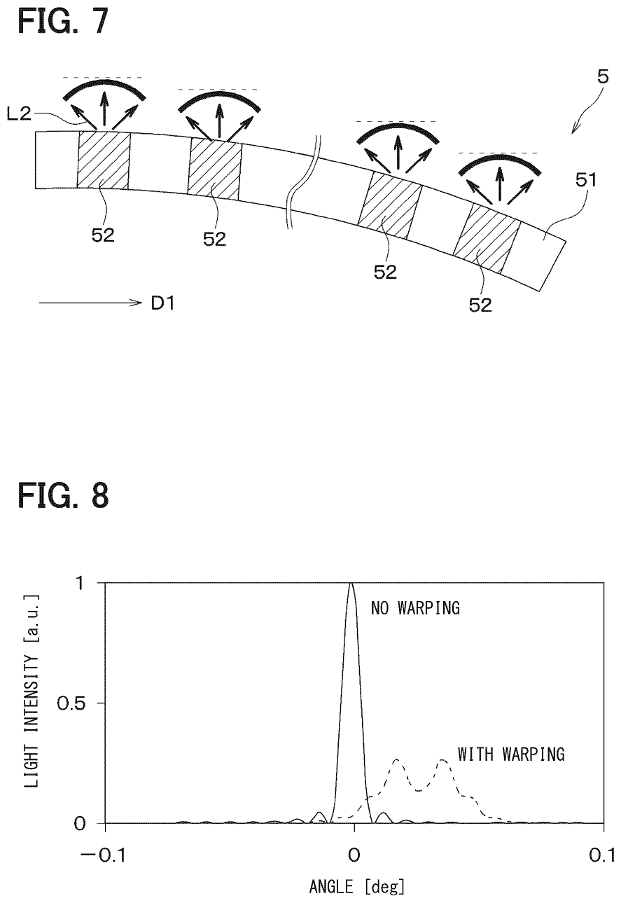

Further, as shown in FIG. 7, when no thickness gradient occurs in the optical antenna 5 but warpage occurs in the vertical direction D1, the emission positions of the respective radiation light from the diffraction gratings 52 are misaligned, resulting in different phase among the radiation light. For example, as shown in FIG. 8, when there is no warpage, the FFP of the light emitted from the optical phased array 4 forms a light beam with high intensity at a predetermined angle, whereas when the above-mentioned warpage occurs, a light beam with high intensity is not formed.

When a thickness gradient or warpage, or both, occur in the optical waveguides 51 of the optical waveguide structure 1, the FFP of the optical phased array 4 changes to an unintended form, resulting in a decrease in the directivity of the light beam. However, the optical waveguide structure 1 includes the correction antennas 6 arranged on both sides of the optical phased array 4. The optical waveguide structure 1 can suppress the decrease in the directivity of the light beam by controlling the temperature distribution using the heater 7 based on analysis results of the FFP of the light emitted from the correction antennas 6.

(Control and Effects of Temperature Distribution) As shown in FIG. 1, the optical waveguide structure 1 can suppress the decrease in the directivity of the light beam by measuring the light emitted from the correction antennas 6 with the optical measurement unit 200, and controlling the temperature distribution with the temperature control unit 300.

The optical measurement unit 200 measures the light emitted from the correction antennas 6 arranged on both sides of the optical phased array 4. The optical measurement unit 200 may be an infrared camera. The data of the emitted light measured by the optical measurement unit 200 may be output to the temperature control unit 300 and used for analyzing the optical characteristics of the correction antennas 6.

The temperature control unit 300 controls the temperature distribution of the semiconductor substrate 10 for suppressing phase deviations in the radiation light L2, which are caused by thickness gradients in the vertical direction D1 of the optical phased array 4 and warping of the semiconductor substrate 10. The temperature control unit 300 may include a microcontroller having a processor such as a CPU, storage media such as ROM and RAM, and input/output (I/O) devices. CPU, ROM, RAM, and I/O are abbreviations for Central Processing Unit, Read Only Memory, Random Access Memory, and Input/Output, respectively. As shown in FIG. 1, the temperature control unit 300 may be configured to include an optical analysis unit 310, a temperature distribution calculation unit 320, and a temperature adjustment unit 330.

The optical analysis unit 310 analyzes the optical characteristics of each of the correction antennas 6 based on the measurement data of the emitted light from the correction antennas 6 that is measured by the optical measurement unit 200. The optical analysis unit 310 analyzes the FFP of the correction antennas 61 and 62, respectively, using known optical analysis techniques.

For example, the optical analysis unit 310 may have multiple pieces of FFP data stored in a recording medium (not shown), that are calculated in advance by the following equation (1). The optical analysis unit 310 compares the FFP data stored in the recording medium with the actually measured FFP of the correction antennas 61 and 62, and estimates film thickness gradient and warpage.

$$E ( θ , ϕ ) = g ( θ , ϕ ) {\sum }_{n = 0}^{N - 1} {a}_{n} exp ( j {ψ}_{n} ) exp ( {jk}_{0} {r}_{n} \cdot R ) = g ( θ , ϕ ) {\sum }_{n = 0}^{N - 1} {a}_{n} exp ( j {ψ}_{n} ) exp [ {jk}_{0} nd sin θ ] \qquad ( Equation 1 )$$

In equation (1), E(θ, φ) denotes the electric field intensity at the orientation θ, φ on a hemispherical surface with a sufficiently large radius centered on the optical emission end of the correction antenna 6, and is proportional to the light intensity of the emitted radiation. When an xy orthogonal coordinate system is established with the optical emission end of the correction antenna 6 as the origin, θ and φ are the orientations corresponding to the x-axis and γ-axis, respectively. The x-axis is the direction in the vertical direction D1. The y-axis is the direction in the normal direction to the plane defined by the vertical direction D1 and the horizontal direction D2. In equation (1), ψₙ is the phase of the radiation emitted from the nth diffraction grating 64, where n is the number of the diffraction gratings 64 arranged in a row in the vertical direction D1, and the diffraction gratings are numbered sequentially from the optical splitter 2 as the first, second, . . . , and nth in the vertical direction D1. In equation (1), rₙ is the emission position coordinate (xₙ, yₙ) of the radiation from the nth diffraction grating 64 in the xy coordinate system. R is the direction vector of the observation point when observing the above-mentioned electric field intensity E(θ, φ). g(θ, φ) is the element directivity of the radiation emitted from a single diffraction grating 64. aₙ is the intensity of the radiation emitted from the nth diffraction grating 64 mentioned above. kₒ represents the wavenumber of the radiation, and d represents the spacing of the diffraction gratings 64. j is the imaginary unit.

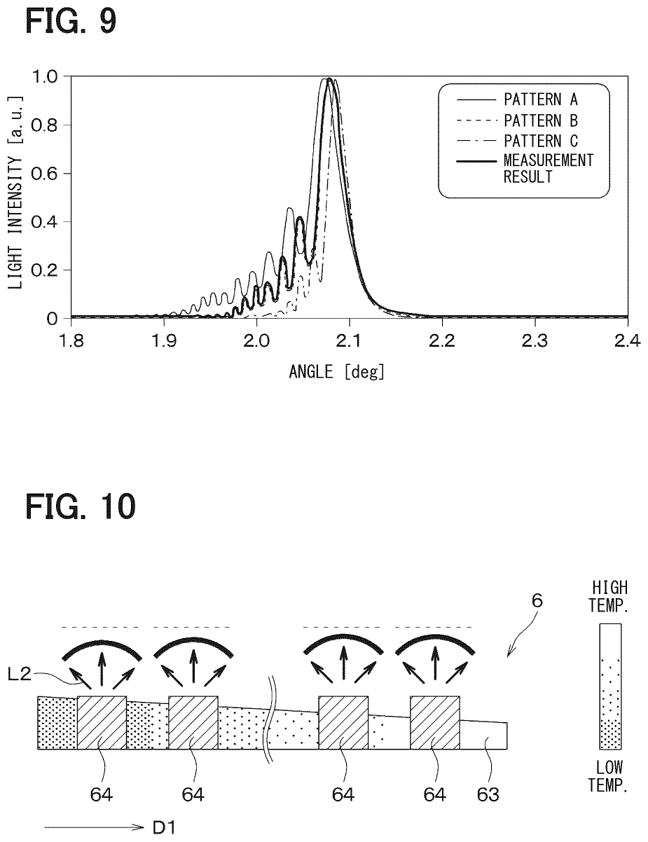

The radiation from the diffraction gratings 64 has a constant phase ψₙ when there is no thickness gradient or warping, as shown in FIG. 4. However, when there is a thickness gradient as shown in FIG. 5, the phase ψₙ changes according to the gradient. ψₙ can be regarded as a term that reflects the effect of the thickness gradient. In addition, when there is no warping, rₙ is (xₙ, 0), and the y-component of the emission position is constant. However, when there is warping, rₙ is (xₙ, yₙ), and the y-component varies according to the warping. In can be regarded as a term that reflects the effect of warping. Multiple combinations (for example, 100 combinations) of possible thickness gradients and warping radii are assumed in advance, and multiple pieces of FFP data corresponding to the combination patterns of the thickness gradients and the warpage are generated by varying ψₙ and rₙ in equation (1) according to the thickness gradient and warping radius. As shown in FIG. 9, the optical analysis unit 310 compares the multiple pieces of pre-generated FFP data described above with the FFP data obtained by actual measurement, and estimates the combination of the thickness gradient and the warping radius that most closely matches the measured FFP. Patterns A, B, and C in FIG. 9 are representative examples of multiple pieces of FFP data, corresponding to different combinations of pre-generated film thickness gradients and warping. In addition, the measurement result in FIG. 9 is an example of FFP data obtained by measuring and analyzing the light emitted from the correction antenna 6. Then, the optical analysis unit 310 may output the estimated results of the thickness gradient and warping for the correction antennas 61 and 62 to the temperature distribution calculation unit 320.

The temperature distribution calculation unit 320 calculates the temperature distribution required to align the FFP of the correction antennas 6, based on the estimated results of the thickness gradient and warping for each of the correction antennas 6, which are obtained from the optical analysis unit 310. As shown in FIG. 10, when only a thickness gradient occurs in the correction antenna 6, the temperature distribution calculation unit 320 calculates the refractive index distribution of the optical waveguide 63 necessary to align the phase of the emitted light from the diffraction gratings 64 arranged in the vertical direction D1. Since the refractive index of the optical waveguide 63 depends on temperature, the temperature distribution calculation unit 320 calculates the temperature distribution of the optical waveguide 63 necessary to align the phase of each emitted light, based on the calculated refractive index distribution, as shown in FIG. 10. In the example of FIG. 10, since the phase of the emitted light is more delayed at the diffraction gratings 64 adjacent to the thinner portions of the optical waveguide 63, a temperature distribution is generated in the optical waveguide 63 such that the temperature increases toward the thinner portions. As a result, the phase deviation of the emitted light from the diffraction gratings 64 caused by the thickness gradient of the optical waveguide 63 can be corrected.

Further, as shown in FIG. 11, when only warping occurs in the correction antenna 6, the temperature distribution calculation unit 320 calculates the temperature distribution of the optical waveguide 63 necessary to align the phase of the emitted light from each of the diffraction gratings 64 arranged in the vertical direction D1, in the same manner as described above. In the example of FIG. 11, since the phase of the emitted light is more delayed at the diffraction gratings 64 located closer to the tip side of the warp of the optical waveguide 63, a temperature distribution is generated in the optical waveguide 63 such that the temperature increases toward the tip side. As a result, the phase deviation of the emitted light from the diffraction gratings 64 caused by the warping of the optical waveguide 63 can be corrected. In FIGS. 10 and 11, for clarity, cases are shown in which either the thickness gradient or warping occurs in the correction antenna 6. However, the temperature distribution calculation unit 320 performs similar calculation processing when both the thickness gradient and warping occur in the correction antenna 6.

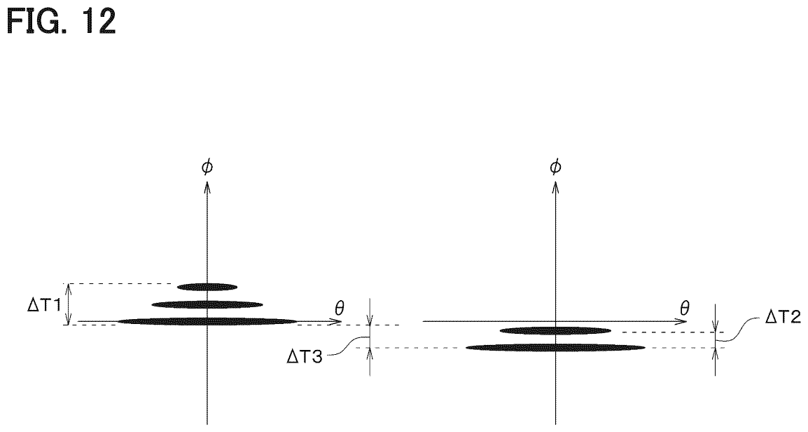

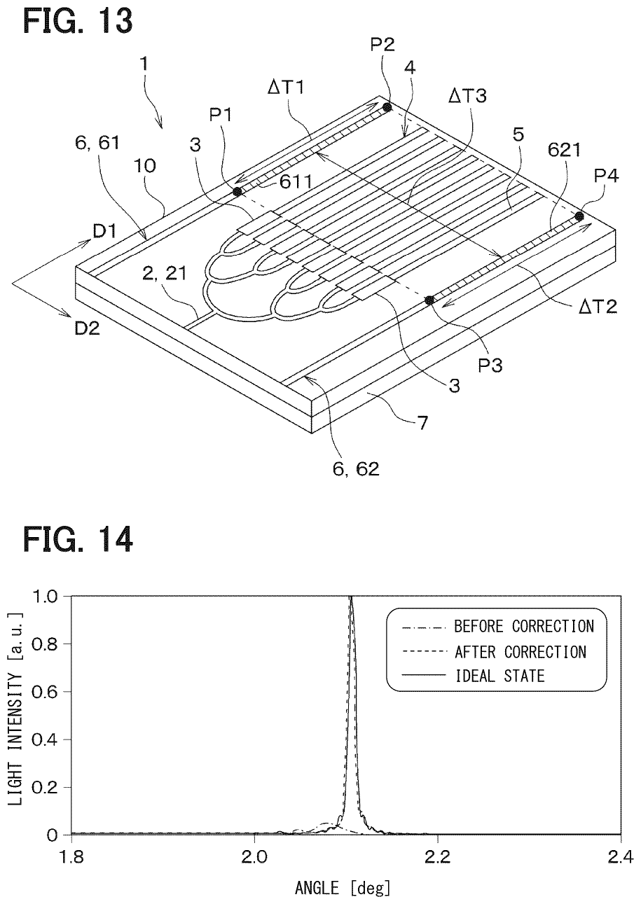

Specifically, assume that the optical analysis unit 310 obtains the FFP of the first correction antenna 61 shown on the left side of FIG. 12 and the FFP of the second correction antenna 62 shown on the right side of FIG. 12. In this case, the temperature distribution calculation unit 320 calculates the temperature distribution ΔT1 required to correct the shape of the FFP of the first correction antenna 61, and the temperature distribution ΔT2 required to correct the shape of the FFP of the second correction antenna 62. As shown in FIG. 13, the temperature distribution ΔT1 is the temperature distribution between points P1 and P2, where the two ends in the vertical direction D1 of the light emission region 611 are designated as the points P1 and P2, respectively. As shown in FIG. 13, the temperature distribution ΔT2 is the temperature distribution between points P3 and P4, where the two ends in the vertical direction D1 of the light emission region 621 are designated as the points P3 and P4, respectively. When temperature control is performed so that the temperature distributions ΔT1 and ΔT2 are achieved for the correction antennas 61 and 62, the shapes of the FFP of the correction antennas 61 and 62 become uniform. However, the positions of these FFP are not yet aligned.

Thus, the temperature distribution calculation unit 320 calculates the temperature distribution ΔT3 required to align the positions of the FFP of the correction antennas 61 and 62. As shown in FIG. 13, the temperature distribution ΔT3 is the temperature distribution in the portion between the light emission region 611 and the light emission region 621 in the horizontal direction D2. Then, when temperature control is performed so that the region between the light emission regions 611 and 621 attains the temperature distribution ΔT3, the positions of the FFP of the correction antennas 61 and 62 become aligned.

Here, simulation results obtained by the present inventors are shown in FIG. 14. In FIG. 14, the “before correction” indicated by the one dot chain line refers to the FFP in the first correction antenna 61 with a warp with a radius of curvature of 10 m and a thickness gradient of 0.1 nm/mm in the vertical direction D1. The “ideal state” shown by the solid line in FIG. 14 refers to the FFP in the first correction antenna 61 without thickness gradient or warp, that is, when each beam of radiation from the diffraction grating 64 has no phase shift. In this case, the temperature distribution ΔT1 required for the FFP of the first correction antenna 61 before correction to have the same shape as the ideal state FFP was 11.5° C. Then, the FFP of the case where the temperature distribution of the light emission region 611 was corrected to ΔT1 was simulated, and the FFP of the first correction antenna 61 “after correction”, which is indicated by the dashed line in FIG. 14, was obtained. The FFP after correction was nearly identical to the FFP in the ideal state. This result suggests that by controlling the temperature distribution of the optical waveguide 63 in the correction antenna 6, where thickness gradient and warp have occurred, it is possible to achieve the FFP that is close to the ideal state without film thickness gradient or warp. Furthermore, by performing the above temperature distribution control correction for each of the correction antennas 6, it is possible to bring the correction antennas 6 closer to the ideal state. Then, by controlling the temperature distribution of the correction antennas 6, the optical phased array 4 sandwiched between the correction antennas 6 is also brought closer to the ideal state, thereby suppressing the deterioration in the directivity of the optical beam caused by thickness gradient and warp.

As described above, the temperature distribution calculation unit 320 calculates, for each of the correction antennas 6, the temperature distribution required to correct the correction antennas 6 to the ideal state, based on the FFP of the radiation light from the correction antennas 6, which are disposed on both sides of the optical phased array 4. The temperature distribution calculation result from the temperature distribution calculation unit 320 may be output to the temperature adjustment unit 330 and used for temperature control with the heater 7.

The temperature adjustment unit 330 executes drive control of the heater 7 based on the above temperature distribution calculation results from the temperature distribution calculation unit 320. The temperature adjustment unit 330 outputs control signals to the heater 7 and performs temperature control so that the temperature distributions in the light emission region 611, the light emission region 621, and a region between the light emission regions 611, 621 are ΔT1, ΔT2, and ΔT3, respectively. As a result, the temperature distributions in the light emission regions 611, 621 and the region between the light emission regions 611, 621 are set to the desired distributions, thereby suppressing the decrease in the optical beam directivity of the optical phased array 4 caused by thickness gradient and warping.

According to the present embodiment, the optical waveguide structure 1 includes the optical phased array 4, and the multiple correction antennas 6 that are optically separated from the optical phased array 4. The correction antennas 6 are arranged facing each other with the optical phased array 4 interposed between. The multiple correction antennas 6 are configured to emit light. The optical waveguide structure 1 is configured to estimate the thickness gradients and warping occurring in the correction antennas 6, based on the FFP of the light emitted from the correction antennas 6. The optical waveguide structure 1 is configured to suppress the decrease in the directivity of the optical beam emitted from the optical phased array 4 by correcting the differences in optical characteristics among the correction antennas 6 so that they are below a predetermined level.

The control method for the optical waveguide structure 1 of the present embodiment includes the following three steps. The first step is measuring the optical characteristics of the light emitted from the correction antennas 6. The second step is calculating the temperature distribution among the correction antennas 6 that is necessary to reduce the difference in optical characteristics of the correction antennas 6, based on the optical characteristics measured in the first step, to a predetermined level or less. The third step is heating the semiconductor substrate 10 using the heater 7 to achieve the temperature distribution calculated in the second step. By this control method, the optical characteristics of the correction antennas 6 are aligned, and the optical characteristics of the optical phased array 4 sandwiched between the correction antennas 6 are improved, thereby suppressing the deterioration in optical beam directivity caused by thickness gradients and warping.

In addition, the optical waveguide structure 1 has the following features.

(1) In the optical waveguide structure 1, the optical antennas 5 and the correction antennas 6 are arranged within the common layer and are made of the same material. As a result, when film thickness gradients and warping occur in the correction antennas 6, similar film thickness gradients and warping may also occur in the optical phased array 4 sandwiched between the correction antennas 6. Then, by performing correction to align the optical characteristics of the correction antennas 6, the optical characteristics of the optical phased array 4 are improved, suppressing deterioration in the directivity of the optical beam more effectively.

(2) In the optical waveguide structure 1, the extending directions of the correction antennas 6 are aligned with the extending directions of the optical antennas 5.

(3) In the optical waveguide structure 1, the number of the correction antennas 6 is less than the number of the optical antennas 5.

(4) The optical waveguide structure 1 further includes the heater 7 configured to heat the optical phased array 4 to generate a predetermined temperature distribution. The heater 7 is a separated member from the semiconductor substrate 10 on which the optical phased array 4 is formed, and is attached to the semiconductor substrate 10. As a result, in the optical waveguide structure 1, the temperature distribution of the correction antennas 6 can be controlled by the heater 7, thereby aligning the optical characteristics of the correction antennas 6. Consequently, this structure enables suppression of the deterioration in directivity of the optical beam from the optical phased array 4.

(Second Embodiment) An optical waveguide structure 1 according to a second embodiment will be described.

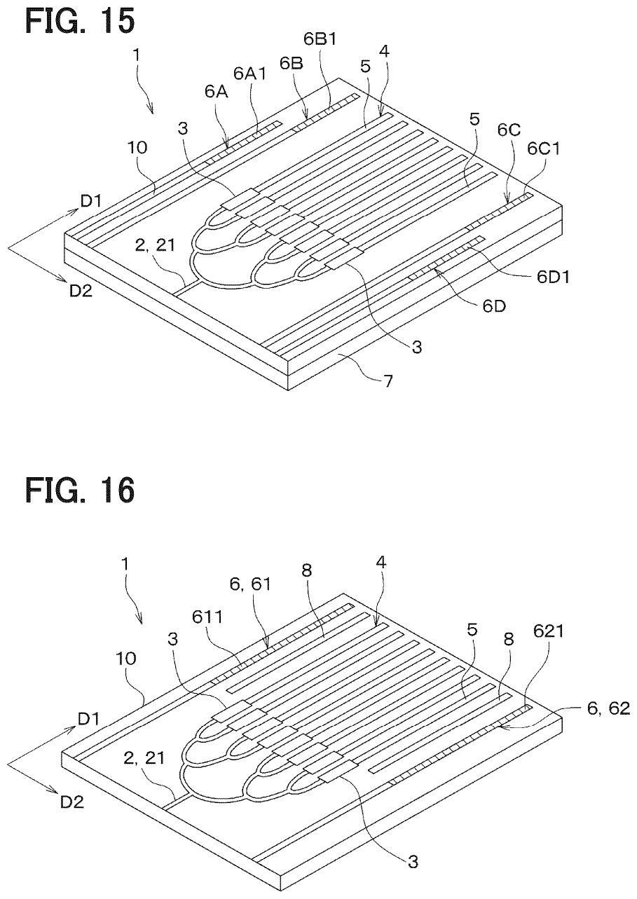

The optical waveguide structure 1 of the present embodiment differs from the first embodiment in that, as shown in FIG. 15, the configuration of the correction antennas 6 has been modified. The following description will mainly focus on this point of difference in the present embodiment.

In the present embodiment, the number of the correction antennas 6 are four. Two of the correction antennas 6 are disposed on the left side of the optical phased array 4 in the horizontal direction D2 and the other two of the correction antennas 6 are disposed on the right side of the optical phased array 4 in the horizontal direction D2. Hereinafter, for convenience of explanation, as shown in FIG. 15, the correction antennas 6 will be referred to, in order from the left side in the horizontal direction D2, as “a first antenna 6A,” “a second antenna 6B,” “a third antenna 6C,” and “a fourth antenna 6D,” respectively. The antennas 6A, 6B, 6C, and 6D are arranged in parallel in the horizontal direction D2, with the extending directions aligned with those of the optical antennas 5. The second antenna 6B is positioned between the optical phased array 4 and the first antenna 6A. The third antenna 6C is positioned between the optical phased array 4 and the fourth antenna 6D.

The second antenna 6B and the third antenna 6C have regions facing the optical antenna 5 in the horizontal direction D6 but not facing the first antenna 6A and the fourth antenna 6D in the horizontal direction D6. The regions are referred to as light emission regions 6B1, 6C1. The other regions of the second antenna 6B and the third antenna 6C are formed only by the optical waveguide 63.

The first antenna 6A and the fourth antenna 6D have regions facing the optical antenna 5 in the horizontal direction D2 as the light emission regions 6A1 and 6D1, and the other regions are formed only by the optical waveguide 63. The light emission regions 6A1 and 6B1 may have the same antenna length, but are not limited thereto. The same applies to the light emission regions 6C1 and 6D1. It should be noted that, as in FIG. 2, hatching is applied to the light emission regions 6A1, 6B1, 6C1, and 6D1 although the hatching does not indicate the cross-section in FIG. 15.

The light emission regions 6A1 and 6B1 are arranged at different positions in the extending direction of the antennas, that is, in the vertical direction D1. The light emission regions 6A1 and 6D1 are positioned at the same positions in the extending direction of the antennas. The light emission regions 6B1 and 6C1 are positioned at the same positions in the extending direction of the antennas. In other words, the first antenna 6A and the fourth antenna 6D form a pair, and the second antenna 6B and the third antenna 6C form a pair.

In the present embodiment, the temperature control unit 300 controls the temperature of the heater 7 so that the difference between the FFP of the first antenna 6A and the FFP of the fourth antenna 6D, as well as the difference between the FFP of the second antenna 6B and the FFP of the third antenna 6C, are each kept within a predetermined value. As a result, the correction accuracy for FFP misalignment caused by the thickness gradient and warpage of the correction antennas 6 arranged on the left and right sides of the optical phased array 4 is further improved, and consequently, the directivity of the optical beam in the optical phased array 4 is ensured. In particular, when the thickness gradient or warpage of the optical waveguides 51 and 63 in the vertical direction D1 is not uniform, the effect of suppressing phase deviation of light in the optical phased array 4 through temperature distribution control is improved compared to the first embodiment described above.

It should be noted that, in the above description, a representative example is given in which two pairs of correction antennas 6, that is, two correction antennas are arranged on each side of the optical phased array 4 in the horizontal direction D2. However, the present disclosure is not limited to this configuration. For example, the correction antennas 6 may include three or more pairs. The number of antennas, the length of the light emission region of each antenna, and other such parameters may be modified as appropriate. In addition, the arrangement of the first antenna 6A and the second antenna 6B, as well as the arrangement of the third antenna 6C and the fourth antenna 6D, may be reversed, and the arrangement of the correction antennas 6 may also be modified as appropriate.

According to the present embodiment, in addition to achieving the same effects as the first embodiment described above, it is possible to further improve the effect of suppressing the decrease in the directivity of the light beam from the optical phased array 4 caused by the thickness gradients and warpage, thereby providing an optical waveguide structure 1 with enhanced performance.

(Third Embodiment) An optical waveguide structure 1 of a third embodiment will be described.

The optical waveguide structure 1 of the present embodiment differs from the first embodiment in that, as shown in FIG. 16, heaters 8 are formed on the semiconductor substrate 10 in place of the heater 7 that is separately formed from the semiconductor substrate 10. The following description will mainly focus on this point of difference in the present embodiment.

The heaters 8 may be microheaters made of titanium nitride (TiN), and are formed directly on the semiconductor substrate 10 by sputtering or the like. The heaters 8 have current supply controlled by the temperature adjustment unit 330, and are used to control the temperature distribution of the optical phased array 4. The number of the heaters 8 is two, and one of the heaters 8 is arranged on one side of the optical phased array 4 in the horizontal direction D2 and the other one is arranged on the other side of the optical phased array 4 in the horizontal direction D2. Each of the heaters 8 is arranged in alignment with the extending direction of the optical antennas 5, and has approximately the same length as the antenna length of the optical antennas 5.

According to the present embodiment as well, the optical waveguide structure 1 having the effects same as those of the above-described first embodiment are obtained. In addition, in the optical waveguide structure 1 of the present embodiment, the heaters 8 are formed directly on the semiconductor substrate 10, so it is not affected by adhesion irregularities as in the method where the heater 7 is separately formed from and bonded to the semiconductor substrate 10. Thus, the effect of suppressing deterioration in temperature distribution control due to adhesion irregularities can also be obtained.

(Other Embodiments) The present disclosure has been described in accordance with the embodiment. However, it is understood that the present disclosure is not limited to these embodiments or structures. The present disclosure also encompasses various modifications and alterations within the scope of equivalents. In addition, various combinations and forms, as well as other combinations and forms including only one, more, or fewer of these elements, are also within the scope and spirit of the present disclosure.

(1) The optical waveguide structures 1 of the above embodiments can be freely combined within the possible range. For example, the optical waveguide structure 1 of the second embodiment may have a configuration including the heaters 8 instead of the heater 7. In addition, in the optical waveguide structures 1 of the above embodiments, the optical antennas 5 and the correction antennas 6 are configured such that the optical waveguides and the diffraction gratings are arranged on the common plane and are separated from each other. However, the present disclosure is not limited to this configuration, and other known configurations of optical antennas may also be employed. It is required that the optical waveguide structure 1 includes multiple correction antennas 6 arranged on both sides of the optical phased array 4, but the configuration of the light emission regions of the optical antennas 5 and the correction antennas 6 may be modified as appropriate.

(2) The control unit (for example, the temperature control unit 300) and its method described in the present disclosure may be implemented by a dedicated computer provided by configuring a processor and memory programmed to execute one or more functions embodied by a computer program. Alternatively, the control unit and its method described in the present disclosure may be implemented by a dedicated computer provided by configuring a processor with one or more dedicated hardware logic circuits. Alternatively, the control unit and its method described in the present disclosure may be implemented by one or more dedicated computers configured by a combination of a processor and memory programmed to execute one or more functions and a processor configured with one or more hardware logic circuits. Further, the computer program may be stored on a computer-readable non-transitory tangible recording medium as instructions to be executed by a computer.

(3) It goes without saying that, in each of the above embodiments, the elements constituting the embodiments are not necessarily essential, except in cases where they are expressly indicated as essential or are considered to be inherently essential in principle. Further, in each of the above embodiments, when the number, numerical values, quantities, ranges, or the like of the components of the embodiment are mentioned, such values are not limited to those specific numbers unless expressly indicated as essential or clearly limited to specific numbers in principle. Further, in each of the above embodiments, when referring to the shape, positional relationship, or the like of components, such shape or positional relationship is not limited thereto unless expressly indicated or inherently limited to a specific shape or positional relationship in principle.

1. An optical waveguide structure comprising:
an optical splitter configured to split an input optical signal to a plurality of optical waveguides;
a plurality of phase adjusters each connected to a respective one of the plurality of optical waveguides, each of the plurality of phase adjusters being configured to control a phase of light propagating through the plurality of optical waveguides;
an optical phased array formed of a plurality of optical antennas, each of the plurality of optical antennas being connected to a respective one of the plurality of phase adjusters; and
a plurality of correction antennas optically isolated from the optical phased array, wherein
the plurality of correction antennas are disposed to face each other, and
the optical phased array is disposed between the plurality of correction antennas.

2. The optical waveguide structure according to claim 1, wherein
the plurality of optical antennas and the plurality of correction antennas are disposed in a common layer and made of a same material.

3. The optical waveguide structure according to claim 1, wherein
the plurality of correction antennas and the plurality of optical antennas extend in a same direction.

4. The optical waveguide structure according to claim 1, wherein
a number of the plurality of correction antennas is less than a number of the plurality of optical antennas.

5. The optical waveguide structure according to claim 1, wherein
the plurality of correction antennas include a first plurality of correction antennas disposed on a first side of the optical phased array and a second plurality of correction antennas disposed on a second side of the optical phased array that is opposite to the first side,
each of the first plurality of correction antennas and each of the second plurality of correction antennas has an optical emission region from which light is emitted outward,
the optical emission regions of the first plurality of correction antennas are offset from each other in an extending direction of the plurality of correction antennas, and
the optical emission regions of the second plurality of correction antennas are offset from each other in the extending direction.

6. The optical waveguide structure according to claim 1, further comprising
a heater configured to heat the optical phased array to produce a predetermined thermal distribution in the optical phased array.

7. The optical waveguide structure according to claim 6, wherein
the heater is separately formed from a semiconductor substrate on which the optical phased array is formed, and
the heater is attached to the semiconductor substrate.

8. The optical waveguide structure according to claim 6, wherein
the heater is integrally formed with a semiconductor substrate on which the optical phased array is formed.

9. The optical waveguide structure according to claim 8, wherein
the heater is one of a plurality of heaters, and
the optical phased array is disposed between the plurality of heaters.

10. A control method of an optical waveguide structure including a semiconductor substrate and a heater configured to heat the semiconductor substrate, the semiconductor substrate including an optical phased array that is formed of a plurality of optical antennas, and a plurality of correction antennas that is optically isolated from the optical phased array and that is disposed to face each other through the optical phased array, the control method comprising:
measuring an optical characteristic of light emitted from the plurality of correction antennas;
calculating, based on the optical characteristic, a target thermal distribution in a region including and between the plurality of correction antennas, wherein the target thermal distribution causes a difference in the optical characteristic among the plurality of correction antennas to fall below a threshold; and
controlling the heater to heat the semiconductor substrate to achieve the target thermal distribution.
